(19) United States
(12) Patent Application Publication
(10) Pub. No.: US 2004/0109015 A1
(43) Pub. Date: Jun. 10, 2004

(54) Multimedia broadcasting apparatus

(76) Inventor: Tom Peng, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/314,200

(22) Filed: Dec. 9, 2002

(51) Int. Cl. G09G 5/00

(52) U.S. Cl. 345/716

(57) ABSTRACT

The present invention provides a multimedia broadcasting apparatus. The multimedia broadcasting apparatus includes one plug-compatible base for providing inserting different specification memory cards and utilizes an interface switching circuitry to switch and connect the interface for a compression and decompression circuitry to compress the written in data and decompress the read out data. The compression and decompression circuitry is connecting with a memory, a signal converting control circuitry, and a multimedia drive circuitry for using the memory storing the data. Then, a signal converting control circuitry is to convert the decompressed read out data from a digital signal into an analog signal and to output a drive order into the multimedia drive circuitry connecting to drive a image display device and a audio broadcast device to output the analog signal. Furthermore, a power supply device is provided for providing the required power for the action of all member mentioned above. Hence, the present invention can directly read out or written in the data with the different specification memory cards to provide the user the broadcasting apparatus provided with the convenience and the humanity design.

### BACKGROUND OF THE INVENTION

1. Field of the Invention

The present invention generally relates to a broadcasting apparatus, and more particularly relates to a video/audio multimedia broadcasting apparatus, which can be compatible with various specification memory cards.

2. Description of the Prior Art

With the development of the information technology (IT) industry, a variety of electronics IT products, such as the cellular phone, the notebook computer, the personal digital assistant (PDA), the digital camera, and the digital picture frame, are become more and more popularly used and provided for different applications, such as the video/audio multimedia and the internet data transmitting, in the usual life. A variety of the miniaturization memory cards, such as the secured digital (SD) memory card, the compact flash miniaturization (CF) memory card, the smart media (SM) card, the memory stick (MS) card or the multimedia card (MMC) are rife with all kinds of the products.

In the variety of electronics products, the main architecture of the digital picture frame is a liquid crystal display (LCD) which is used for reading out the digital photography file, such as the JPEG file, within the all kinds of memory cards to display the photograph and usually collocate with the use of the digital camera. So as the digital picture frame can edit the photography pictured within the digital camera and display for viewing. However, conventional digital cameras of different brands are using different specification memory cards and general digital picture frame display products are suitable for using the specific specification the memory card of the brand. For example, the CF memory card or the SM memory card can be suitable for the general digital picture frame products, but the MS card cannot be suitable. Hence, the user must transmit the photograph file stored within the MS card to the CF memory card or the SM memory card and then the photograph can be read out via the digital picture frame. However, the transmitting action must connect the digital camera and the computer or utilize the card reader to connect the digital camera and the computer so as to transmit the photograph file stored within the MS card to the computer and then to utilize the card reader to transmit and store the photograph to the CF memory card or the SM memory card. The use is very inconvenient for the user. Furthermore, the conventional digital picture frame can only read out and display the digital photograph file, but cannot write in or broadcast the video/audio file of the movement state. Even the digital picture frame is a high-price product, but practicability of the digital picture frame is not very high.

On the other hand, the advertisement lamp boxes are commonly seen in the public rapid transit system, the railroad (or bus) station, or used by the bridal dressing dealer. The advertisement lamp boxes provide with the advertisement effect of the vision fascinating. However, the whole lamp box must be replaced when the advertisement photograph is renewed, which is inconvenient and less economic benefits.

Obviously, the main spirit of the present invention is to provide a multimedia broadcasting apparatus, and then some disadvantages of well-known technology are overcome. The present invention not only provides to display the static photograph, but also the present invention can provide to broadcast the video and the audio file of the movement state.

### SUMMARY OF THE INVENTION

The primary object of the present invention is to provide a multimedia broadcasting apparatus so as the present invention utilize an interface switching circuitry to switch and connect different interfaces to integrate various conventional used memory cards to promptly written in or read out in the same apparatus and the present invention can improve the convenience and the practicability for users and extend the application category of the digital picture frame.

Another object of the present invention is to provide a multimedia broadcasting apparatus so as the present invention can enhance the use effect of the digital picture frame. The present invention not only can display the static photograph, but also provide to broadcast the video/audio file of the movement state. The present invention can immediately and promptly renew the photograph and the video required displaying via a wireless transmitting module.

A further object of the present invention is to provide a multimedia broadcasting apparatus which can be designed as a miniaturization portable video/audio multimedia broadcasting apparatus or as a digital picture frame, light box, hand box, and electronics advertisement media, such as the large-sized display media.

A furthermore object of the invention is to provide a multimedia broadcasting apparatus which can provide the two-way function of the data read out or written in and can perform the editing or the backup of the video/audio data via an universal serial bus (USB) connecting port provided with and connecting with a computer.

In order to achieve previous objects, the multimedia broadcasting apparatus of the present invention includes at least one plug-compatible base for providing inserting different specification memory cards, wherein the plug-compatible base is electrically connecting with an interface switching circuitry so as to switch the interface for data read out or data written in the memory card; a compression and decompression circuitry connecting the interface switching circuitry so as to compress the written in data and decompress the read out data; a memory connecting the compression and decompression circuitry for storing the read out and written in data and providing a related information for storing; a signal converting control circuitry connecting the compression and decompression circuitry so as to convert the decompressed read out data from a digital signal into an analog signal and to output a drive order; a multimedia drive circuitry connecting the signal converting control circuitry so as to drive a multimedia apparatus to output the analog signal accordingly to the drive order; and a power supply device for providing the required power for the action of all member mentioned above.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the architecture of the block diagram, in accordance with the present invention;

FIG. 2 is a schematic representation of the advertisement lamp box, in accordance with one preferred embodiment of the present invention; and

FIG. 3 is a schematic representation of the hand box, in accordance with another embodiment of the present invention.

### DESCRIPTION OF THE PREFERRED EMBODIMENT

The present invention utilizes an interface switch circuitry for dealing with the insertion of different memory cards to switch to its compatible connecting interface. The present invention further matches with the use of a compression and decompression circuitry so as a multimedia broadcasting apparatus can utilize only a single socket to read out or written in the different memory cards. Hence, the present invention can expand the application field of the prior digital picture frame and provides the user the more humanized electronics products.

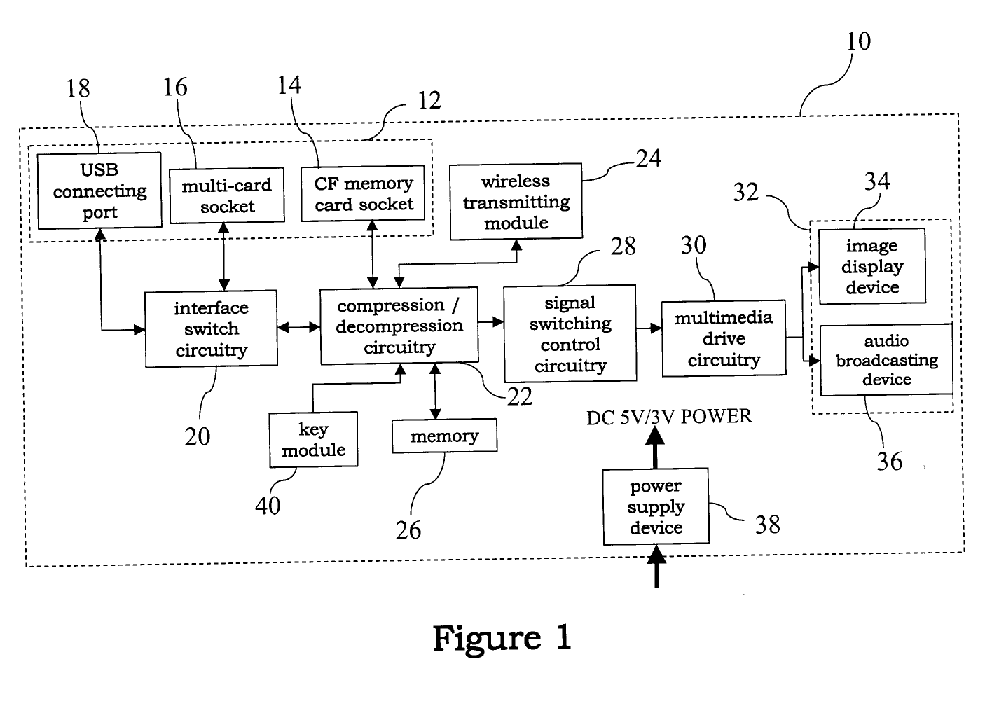

Referring to the FIG. 1, it is a schematic representation of the architecture of the block diagram in accordance with the present invention. A multimedia broadcasting apparatus 10 includes a plug-compatible base 12. The plug-compatible base 12 comprises two sockets and a universal Serial bus (USB) connecting port 18. One of the sockets is a CF memory card socket 14 and another one is a multi-card socket 16 so as the CF memory card socket 14 can provide the insertion and connection for the most used CF memory card and the multi-card socket 16 can provide the insertion and connection for the different specification memory cards, such as the secured digital (SD) memory card, the compact flash miniaturization (CF) memory card, the smart media (SM) card, the memory stick (MS) card or the multimedia card (MMC). The present invention utilizes the USB connecting port 18 to connect with a computer system, such as the personal computer, the notebook computer, and the digital camera, which are provided with the USB socket, so as to perform the storage, the backup, and the edition of the photograph or the video/audio digital data. The multi-card socket 16 and the USB connecting port 18 are respectively electrically connecting with the same an interface switch circuitry 20 and then connecting to a compression and decompression circuitry 22. Hence, the present invention can switch the connecting interface when the multi-card socket 16 is inserted with different specification memory card so as to read out and writing in the data into the memory card via the USB connecting port 18 connected with a computer system to switch the connecting as the USB connecting interface. The compression and decompression circuitry 22 connected with the interface switch circuitry 20 is arranged a micro-controller therein for compressing the written in data and the decompressing the read out data and utilizing the micro-controller to control and connecting the action between each elements.

The compression and decompression circuitry 22 are respectively connecting with a wireless transmitting module 24, a memory 26, and a signal switching control circuitry 28. Wherein the wireless transmitting module 24 is a transmitting module of an 802.11b Communication Agreement so as to perform the wireless transmitting to renew the video/audio digital data at any time. Usually, the memory 26 is a flash memory or an electrically erasable programmable read only memory (EEPROM) to store the read out or written in data within the memory and the computer and to the use of storing the related data of the built-in program or software. The memory 26 usually comprises a random access memory (RAM) for temporarily data storing at the process of the data transmitting. The signal switching control circuitry 28 is used to convert the decompressed read out data from a digital signal into an analog signal and to output a drive order to a multimedia drive circuitry 30. The multimedia drive circuitry 30 is connecting to a multimedia apparatus 32 so as the multimedia apparatus 32 can drive the multimedia apparatus 32 to output the analog signal accordingly to the drive order. The multimedia apparatus 32 comprises a image display device 34 and a audio broadcasting device 36, wherein the image display device 34 is usually a liquid crystal display (LCD) and the audio broadcasting device 36 can broadcast the MP3 file or other audio files. The present invention utilizes the image display device 34 to display the photograph and utilizes the audio broadcasting device 36 to broadcast the video file or the audio file. The present invention further comprises a key module 40, which is connecting the compression and decompression circuitry 22 so as to provide the operation setting of all function for the multimedia broadcasting apparatus 10, and a power supply device 38, which is usually the 5V/3V battery, for providing the required power for the action of all member mentioned above.

In the present invention, the circuitry arranged within the multimedia broadcasting apparatus 10 is formed by the system on a chip (SOC) of the integrated circuit, so the present invention can be a portable video/audio multimedia broadcasting apparatus with a miniaturization design or to design the image display device 34 as a large-sized LCD panel. Hence, the multimedia broadcasting apparatus 10 of the present invention can apply to a digital picture frame, the advertisement light box, the hand box, the mobile presenter combining with the projector, the media table combining with the projector and the table, and electronics advertisement media, such as the large-sized display media.

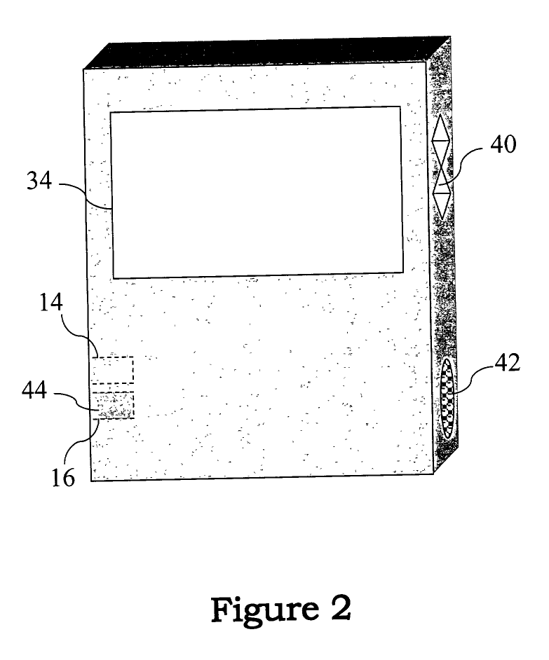

Referring to the FIG. 2, it is a schematic representation of the advertisement lamp box in accordance with one preferred embodiment of the present invention. The structure of the outward appearance includes a LCD image display device 34, a trumpet 42, a key module 40, a CF memory card socket 14, and a multi-card socket 16, wherein the internal circuitry structure is the same as the mentioned above. Referring back to the FIG. 1, if a memory card 44, which is not the CF memory card, must be used, the memory card 44 can be inserted into the multi-card socket 16 and then the interface switching circuitry 20 will switch the connecting interface into the corresponding interface of the memory 44. A this time, the present invention can utilize the key module 40 to store the file, such as the JEPG photograph file or the video compression format of MPEG-1 or MPEG-2, in the memory 26 via the micro-controller within the compression and decompression circuitry 22. Then, the memory 44 is taken out and the key module 40 is used to choose the file content for broadcasting. The compression and decompression circuitry 22 will read out the chosen file from the memory 26. If the chosen file is a video compressed format file, the chosen file will be decompressed. Then, the signal switching control circuitry 28 will convert the decompressed file into an analog video/audio signal to output to the multimedia drive circuitry 30 and simultaneously to deliver a drive order to the multimedia drive circuitry 30. In accordance with the drive order, the multimedia drive circuitry 30 will drive the LCD image display device 34 to display the analog video signal as the video appearance and drive the audio broadcasting device 36 to broadcast the analog audio signal via the trumpet 42 to broad and broadcast the audio.

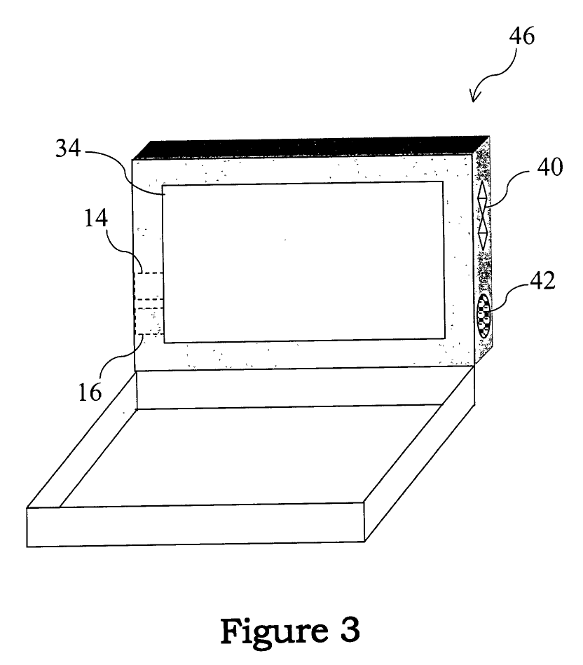

Referring to the FIG. 3, it is a schematic representation of the hand box in accordance with another embodiment of the present invention. The outward appearance of the hand box 46 is similar to the advertisement lamp box mentioned above. The hand box 46 also includes a LCD image display device 34, a trumpet 42, a key module 40, a CF memory card socket 14, and a multi-card socket 16, wherein the internal circuitry structure is arranged within the back side space of the LCD image display device 34, such as the same in the FIG. 1. Furthermore, the action procedure of the use of the hand box 46 and the connecting relationship of the circuit signal are the same as the mentioned above and will not give unnecessary details herein.

In the present invention, the multimedia broadcasting apparatus not only can broadcast the stored video/audio file within the memory 26, but also can directly read out or writing in the data within the memory card 44 and to directly broadcast the video/audio file within the memory card 44 after inserting the memory card into the multi-card socket 16. The relationship between the broadcasting file and the signal connection are same to the action procedure mentioned above and will not give unnecessary details herein. Therefore, if the user wants to broadcast the multimedia content within different memory card 44, it only needs to replace the memory card 44 without performing the converting via the computer. Hence, the present invention can provide the user a very convenient and humanized multimedia broadcasting apparatus.

Besides, the present invention not only can read out the data within the memory card 44, but also can write in the data within the memory 26 into the memory card 44 by utilizing the compression and decompression circuitry 22 and via the connection of the interface switching circuitry 20 and the plug-compatible base 12. Hence, the present invention is not only a broadcasting media to overcome some disadvantages of well-known technology, but also provides the two-way function of the data read out or written in and perform the editing or the backup of the video/audio data via an universal serial bus (USB) connecting port provided with and connecting with a computer to expand the application effect of the multimedia broadcasting apparatus.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A multimedia broadcasting apparatus comprising:
at least one plug-compatible base for providing inserting different specification memory cards;
an interface switching circuitry electrically connecting with said plug-compatible base so as to switch the interface for data read out or data written in said memory card;
a compression and decompression circuitry connecting said interface switching circuitry so as to compress said written in data and decompress said read out data;
a memory connecting said compression and decompression circuitry for storing said read out and written in data and providing a related information for storing;
a signal converting control circuitry connecting said compression and decompression circuitry so as to convert said decompressed read out data from a digital signal into an analog signal and to output a drive order;
a multimedia drive circuitry connecting said signal converting control circuitry so as to drive a multimedia apparatus to output said analog signal accordingly to said drive order; and
a power supply device for providing the required power for the action of all member mentioned above.

2. The multimedia broadcasting apparatus according to claim 1, further includes a key module.

3. The multimedia broadcasting apparatus according to claim 1, wherein said plug-compatible base further includes more than two sockets which one of said sockets is a compact flash (CF) memory card socket.

4. The multimedia broadcasting apparatus according to claim 1, wherein said plug-compatible base further includes a universal Serial bus (USB) connecting port which is connecting to said interface switching circuitry.

5. The multimedia broadcasting apparatus according to claim 1, wherein said memory card inserted in said plug-compatible base is selected from the group of a secured digital memory card, a multimedia card, a smart media, a memory stick card, and a compact flash memory card.

6. The multimedia broadcasting apparatus according to claim 1, wherein said memory is selected from the group of the random access memory (RAM), the flash memory, and the electrically erasable programmable read only memory (EEPROM).

7. The multimedia broadcasting apparatus according to claim 1, wherein said related information for said memory storing includes a built-in program and software.

8. The multimedia broadcasting apparatus according to claim 1, wherein said multimedia broadcasting apparatus is selected from the group of the image display device and the audio broadcast device.

9. The multimedia broadcasting apparatus according to claim 1, wherein said multimedia drive circuitry is driving the file in said multimedia apparatus and to broadcast the file which is selected from the group of the graphic file, the video file, and the audio file.

10. The multimedia broadcasting apparatus according to claim 1, wherein said signal converting control circuitry is further connecting with a wireless transmitting module.
